(19) United States
(12) Patent Application Publication
(10) Pub. No.: US 2021/0179079 A1
(43) Pub. Date: Jun. 17, 2021

(54) PARKING ASSIST SYSTEM

(71) Applicant: HONDA MOTOR CO., LTD., Tokyo (JP)

(72) Inventors: Yuki HARA, Saitama (JP); Yuki NAKADA, Saitama (JP); Syoichi KOBAYASHI, Saitama (JP); Yasushi SHODA, Saitama (JP)

(21) Appl. No.: 17/098,639

(22) Filed: Nov. 16, 2020

(30) Foreign Application Priority Data
Dec. 13, 2019 (JP) 2019-225935

(51) Int. Cl. B60W 30/06; B60W 50/10; B60W 50/12; B60W 10/18; G06K 9/00

(52) U.S. Cl. CPC B60W 30/06; B60W 50/10; B60W 2554/20; B60W 10/18; G06K 9/00805; B60W 50/12

(57) ABSTRACT

A parking assist system for a vehicle includes a control device configured to execute an automatic parking process for autonomously moving the vehicle from a current position to a parking position. The control device is configured such that in a case where the control device has stopped the vehicle according to detection of an obstacle by an external environment sensor in a prescribed range from the parking position during execution of the automatic parking process, the control device does not permit resumption of movement of the vehicle in the automatic parking process, and in a case where the control device has stopped the vehicle according to an operation of a brake operation member by the driver in the prescribed range from the parking position during the execution of the automatic parking process, the control device permits the resumption of movement of the vehicle in the automatic parking process.

### TECHNICAL FIELD

The present invention relates to a parking assist system that moves a vehicle autonomously from a current position to a target position.

### BACKGROUND ART

JP2015-120403A discloses that a shift position of a shift lever is shifted to a parking position at the end of an automatic parking process.

During an automatic parking process of a vehicle, the vehicle may be stopped by the system performing the automatic parking process or by an operation of the brake by the driver. The system may stop the vehicle in cases such as when an obstacle is detected the trajectory (travel route) set in the automatic parking process or in the vicinity thereof or when failure of the system is detected. Particularly, when an obstacle is detected at or near the parking position, there is a high possibility that the vehicle cannot be parked in the parking position. In this case, the driving mode is switched to manual driving or the automatic parking process is performed again from the first, and therefore, it is preferred to switch the shift position (shift range) of the shift lever to the parking position (parking range) so that the driver can safely perform the operation after the cancellation of the automatic parking process.

On the other hand, the driver may stop the vehicle by operating the brake in such cases as when the driver finds an obstacle on the travel route or when the driver finds an object that, from the subjective point of view of the driver, may have a risk of contacting the vehicle though objectively the object imposes no problem. In the latter case or in a case where when a pedestrian temporarily crosses the travel route of the vehicle, it can be assumed that the driver has no intention of canceling the automatic parking process and desires to continue the automatic parking process. In such cases, if the automatic parking process is canceled, the driver's convenience will be impaired.

As described above, when the vehicle is stopped during the automatic parking process, in some cases it is preferred to cancel the automatic parking process and in other cases it is preferred to temporarily suspend the automatic parking process so that the automatic parking process can be resumed.

### SUMMARY OF THE INVENTION

In view of such problems, an object of the present invention is to provide a parking assist system that can improve the safety and convenience of the vehicle when the vehicle is stopped near the parking position.

One aspect of the present invention provides a parking assist system (1) for a vehicle including a powertrain (4), a brake device (5), and a steering device (6), the parking assist system comprising: a control device (15) configured to execute an automatic parking process for autonomously moving the vehicle from a current position to a parking position; and a vehicle position detection device (7, 10) including an external environment sensor (7) configured to detect an obstacle, the vehicle position detection device being configured to detect a position of the vehicle relative to a travel route for the automatic parking process, wherein the vehicle includes a brake operation member (24, 52) that can be operated by a driver to operate the brake device, and the control device is configured such that in a case where the control device has stopped the vehicle according to detection of the obstacle by the external environment sensor in a prescribed range from the parking position during execution of the automatic parking process, the control device does not permit resumption of movement of the vehicle in the automatic parking process, and in a case where the control device has stopped the vehicle according to an operation of the brake operation member by the driver in the prescribed range from the parking position during the execution of the automatic parking process, the control device permits the resumption of movement of the vehicle in the automatic parking process.

When the vehicle is stopped according to the detection of the obstacle in the prescribed range, it is likely that continuation of the automatic parking process is difficult, and therefore, in the above configuration, the resumption of the automatic parking process is not permitted so that the safety is ensured. Also, when the vehicle is stopped according to the brake operation by the driver, there is low risk that the vehicle may collide an obstacle, and therefore, in the above configuration, the resumption of the automatic parking process is permitted so that the driver's convenience is improved and an increase in time until the completion of parking can be suppressed.

In the above configuration, preferably, the powertrain includes a transmission (16), the vehicle further includes a shift device (25) that can be operated by the driver to operate the transmission, and the control device is configured to switch a shift range of the shift device to a parking range (P) in a case where the control device does not permit the resumption of movement of the vehicle in the automatic parking process.

According to this configuration, in the case where the resumption of the automatic parking process is not permitted, the shift range of the shift device is switched to the parking range (P) so that the vehicle is fixed in place and the safety is improved.

Preferably, the parking assist system further comprises a brake sensor (27) configured to detect an operation of the brake operation member by the driver for activating the brake device, wherein when the brake sensor detects the operation of the brake operation member by the driver after the control device has stopped the vehicle and switched the shift range of the shift device to the parking range (P), the control device ends the automatic parking process.

According to this configuration, the driver is required to perform the brake operation before the automatic parking process is canceled, whereby the driver can easily recognize the transfer of vehicle control (or driving authority) to the driver.

In the above configuration, preferably, the brake device includes a parking brake device (53), and the control device is configured such that in a case where the control device has stopped the vehicle according to detection of an abnormality in the vehicle during the automatic parking process, the control device does not permit the resumption of movement of the vehicle in the automatic parking process, switches the shift range of the shift device to the parking range, and activates the parking brake device.

According to this configuration, in the case where the automatic parking process is canceled according to the detection of a failure in the vehicle, the parking brake device is activated so that the vehicle is fixed in place more reliably and the safety is improved.

Another aspect of the present invention provides a parking assist system (1) for a vehicle including a powertrain (4), a brake device (5), and a steering device (6), the parking assist system comprising: control device (15) configured to execute an automatic parking process for autonomously moving the vehicle from a current position to a parking position; and a vehicle position detection device (7, 10) including an external environment sensor (7) configured to detect an obstacle, the vehicle position detection device being configured to detect a position of the vehicle relative to a travel route for the automatic parking process, wherein in a case where the control device has stopped the vehicle according to the control device detection of the obstacle by the external environment sensor and a prescribed condition is satisfied, the control device shifts the parking position from an initial parking region (54) to a secondary parking region (55) that is positioned more remote from the obstacle than the initial parking region is, the prescribed condition being satisfied when (i) the parking position is the initial parking region and (ii) the vehicle has progressed one third or more of a fore and aft length of the initial parking region into the initial parking region.

In the above configuration, preferably, it is further necessary, in order for the prescribed condition to be satisfied, that (iii) the control device has stopped the vehicle according to detection of the obstacle by the external environment sensor in a state where the vehicle has partially progressed into the initial parking region, and the travel route of the vehicle to the initial parking region has been recalculated prescribed times.

In the above configuration, preferably, the control device is configured such that when, during movement of the vehicle toward the secondary parking region in the automatic parking process, the control device has stopped the vehicle according to detection of the obstacle by the external environment sensor in a state where the vehicle has partially progressed into the secondary parking region, the control device cancels the automatic parking process.

In the above configuration, preferably, the initial parking region and the secondary parking region each have a substantially rectangular shape inscribed in an outline of the vehicle positioned in the parking position in plan view.

According to the present invention, it is possible to provide a parking assist system that can improve the safety and convenience of the vehicle when the vehicle is stopped near the parking position.

### BRIEF DESCRIPTION OF THE DRAWINGS

FIG. 1 is a functional block diagram of a vehicle provided with a parking assist system according to an embodiment of the present invention;

FIG. 2 is a flow chart of an automatic parking process in the parking assist system according to the embodiment;

FIG. 3A is a diagram showing a screen display of a touch panel during a target parking position reception process in the parking assist system according to the embodiment;

FIG. 3B is a diagram showing the screen display of the touch panel during a driving process in the parking assist system according to the embodiment;

FIG. 3C is a diagram showing the screen display of the touch panel when automatic parking is completed in the parking assist system according to the embodiment;

FIG. 4 is a flow chart showing details of the automatic parking process in the parking assist system according to the embodiment;

FIG. 5 is a plan view showing a trajectory of the vehicle during the automatic parking process in the parking assist system according to the embodiment;

FIG. 6A is a diagram showing the screen display of the touch panel when the automatic parking process is to be canceled;

FIG. 6B is a diagram showing the screen display of the touch panel for selection of cancellation or resumption;

FIG. 7 is a flowchart of the automatic parking process performed by the parking assist system according to another embodiment;

FIG. 8A is an explanatory diagram showing the automatic parking process performed by the parking assist system according to the other embodiment;

FIG. 8B is another explanatory diagrams showing the automatic parking process performed by the parking assist system according to the other embodiment;

FIG. 8C is another explanatory diagrams showing the automatic parking process performed by the parking assist system according to the other embodiment; and

FIG. 8D is another explanatory diagrams showing the automatic parking process performed by the parking assist system according to the other embodiment.

### DESCRIPTION OF THE PREFERRED EMBODIMENT(S)

In the following, an embodiment of the present invention will be described in detail with reference to the drawings.

A parking assist system 1 is mounted on a vehicle such as an automobile provided with a vehicle control system 2 configured to make the vehicle travel autonomously.

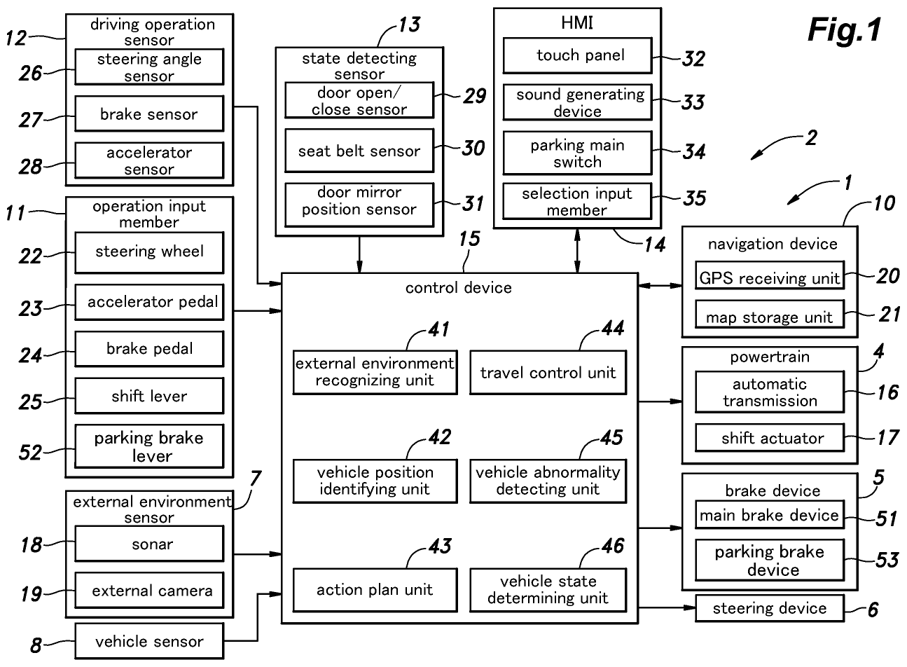

As shown in FIG. 1, the vehicle control system 2 includes a powertrain 4, a brake device 5, a steering device 6, an external environment sensor 7, a vehicle sensor 8, a navigation device 10, an operation input member 11, a driving operation sensor 12, a state detecting sensor 13, a human machine interface (HMI) 14, and a control device 15. The above components of the vehicle control system 2 are connected to each other so that signals can be transmitted therebetween via communication means such as a Controller Area Network (CAN).

The powertrain 4 is a device configured to apply a driving force to the vehicle. The powertrain 4 includes a power source and a transmission, for example. The power source includes at least one of an internal combustion engine, such as a gasoline engine and a diesel engine, and an electric motor. In the present embodiment, the powertrain 4 includes an automatic transmission 16 and a shift actuator 17 for changing a shift position of the automatic transmission 16 (a shift position of the vehicle). The brake device 5 is a device configured to apply a brake force to the vehicle. For example, the brake device 5 includes a brake caliper configured to press a brake pad against a brake rotor and an electric cylinder configured to supply an oil pressure to the brake caliper. The brake device 5 may include an electric parking brake device 53 configured to restrict rotations of wheels via wire cables. The steering device 6 is a device for changing a steering angle of the wheels. For example, the steering device 6 includes a rack-and-pinion mechanism configured to steer (turn) the wheels and an electric motor configured to drive the rack-and-pinion mechanism. The powertrain 4, the brake device 5, and the steering device 6 are controlled by the control device 15.

The external environment sensor 7 serves as an external environment information acquisition device for detecting electromagnetic waves, sound waves, and the like from the surroundings of the vehicle to detect an object outside the vehicle and to acquire surrounding information of the vehicle. The external environment sensor 7 includes sonars 18 and external cameras 19. The external environment sensor 7 may further include a millimeter wave radar and/or a laser lidar. The external environment sensor 7 outputs a detection result to the control device 15.

Each sonar 18 consists of a so-called ultrasonic sensor. Each sonar 18 emits ultrasonic waves to the surroundings of the vehicle and captures the ultrasonic waves reflected by an object around the vehicle thereby to detect a position (distance and direction) of the object. Multiple sonars 18 are provided at each of a rear part and a front part of the vehicle. In the present embodiment, two pairs of sonars 18 are provided on a rear bumper so as to be spaced laterally from each other, two pairs of sonars 18 are provided on a front bumper so as to be spaced laterally from each other, one pair of sonars 18 is provided at a front end portion of the vehicle such that the two sonars 18 forming the pair are provided on left and right side faces of the front end portion of the vehicle, and one pair of sonars 18 is provided at a rear end portion of the vehicle such that the two sonars 18 forming the pair are provided on left and right side faces of the rear end portion of the vehicle. That is, the vehicle is provided with six pairs of sonars 18 in total. The sonars 18 provided on the rear bumper mainly detect positions of objects behind the vehicle. The sonars 18 provided on the front bumper mainly detect positions of objects in front of the vehicle. The sonars 18 provided at the left and right side faces of the front end portion of the vehicle detect positions of objects on left and right outsides of the front end portion of the vehicle, respectively. The sonars 18 provided at the left and right side faces of the rear end portion of the vehicle detect positions of objects on left and right outsides of the rear end portion of the vehicle, respectively.

The external cameras 19 are devices configured to capture images around the vehicle. Each external camera 19 consists of a digital camera using a solid imaging element such as a CCD or a CMOS, for example. The external cameras 19 include a front camera for capturing an image in front of the vehicle and a rear camera for capturing an image to the rear of the vehicle. The external cameras 19 may include a pair of left and right side cameras that are provided in the vicinity of the door mirrors of the vehicle to capture images on left and right sides of the vehicle.

The vehicle sensor 8 includes a vehicle speed sensor configured to detect the speed of the vehicle, an acceleration sensor configured to detect the acceleration of the vehicle, a yaw rate sensor configured to detect the angular velocity around a vertical axis of the vehicle, and a direction sensor configured to detect the direction of the vehicle. For example, the yaw rate sensor consists of a gyro sensor.

The navigation device 10 is a device configured to obtain a current position of the vehicle and provides route guidance to a destination and the like. The navigation device 10 includes a GPS receiving unit 20 and a map storage unit 21. The GPS receiving unit 20 identifies a position (latitude and longitude) of the vehicle based on a signal received from an artificial satellite (positioning satellite). The map storage unit 21 consists of a known storage device such as a flash memory or a hard disk, and stores map information.

The operation input member 11 is provided in a vehicle cabin to receive an input operation performed by the occupant (user) to control the vehicle. The operation input member 11 includes a steering wheel 22, an accelerator pedal 23, a brake pedal 24 (brake input member), and a shift lever 25 (shift member). The shift lever 25 is configured to receive an operation for switching the shift position of the vehicle.

The driving operation sensor 12 detects an operation amount of the operation input member 11. The driving operation sensor 12 includes a steering angle sensor 26 configured to detect a steering angle of the steering wheel 22, a brake sensor 27 configured to detect a pressing amount of the brake pedal 24, and an accelerator sensor 28 configured to detect a pressing amount of the accelerator pedal 23. The driving operation sensor 12 outputs a detected operation amount to the control device 15.

The state detecting sensor 13 is a sensor configured to detect a change in a state of the vehicle according to an operation by the occupant. The operation by the occupant detected by the state detecting sensor 13 includes an operation indicating an alighting intention (intention to alight from the vehicle) of the occupant and an operation indicating absence of an intention of the occupant to check the surroundings of the vehicle during an autonomous parking operation or an autonomous unparking operation. The state detecting sensor 13 includes, as sensors for detecting the operation indicating the alighting intention, a door open/close sensor 29 configured to detect opening and/or closing of a door of the vehicle and a seat belt sensor 30 configured to detect a fastening state of a seat belt. The state detecting sensor 13 includes, as a sensor to detect the operation corresponding to the abdicating intention, a door mirror position sensor 31 configured to detect a position of a door mirror. The state detecting sensor 13 outputs a signal indicating a detected change in the state of the vehicle to the control device 15.

The HMI 14 is an input/output device for receiving an input operation by the occupant and notifying the occupant of various kinds of information by display and/or voice. The HMI 14 includes, for example, a touch panel 32 that includes a display screen such as a liquid crystal display or an organic EL display and is configured to receive the input operation by the occupant, a sound generating device 33 such as a buzzer or a speaker, a parking main switch 34, and a selection input member 35. The parking main switch 34 receives the input operation by the occupant to execute selected one of an automatic parking process (autonomous parking operation) and an automatic unparking process (autonomous unparking operation). The parking main switch 34 is a so-called momentary switch that is turned on only while a pressing operation (pushing operation) is performed by the occupant. The selection input member 35 receives a selection operation by the occupant related to selection of the automatic parking process and the automatic unparking process. The selection input member 35 may consist of a rotary select switch, which preferably requires pressing as the selection operation.

The control device 15 consists of an electronic control unit (ECU) that includes a CPU, a nonvolatile memory such as a ROM, a volatile memory such as a RAM, and the like. The CPU executes operation processing according to a program so that the control device 15 executes various types of vehicle control. The control device 15 may consist of one piece of hardware, or may consist of a unit including multiple pieces of hardware. Further, the functions of the control device 15 may be at least partially executed by hardware such as an LSI, an ASIC, and an FPGA, or may be executed by a combination of software and hardware.

Further, the control device 15 executes an arithmetic process according to a program and thereby performs a conversion process of an image (video) captured by the external cameras 19 so as to generate a look-down image corresponding to a plan view of the vehicle and its surrounding area and a bird's-eye image corresponding to a three-dimensional image of the vehicle and a part of its surrounding area positioned in the travel direction as viewed from above. The control device 15 may generate the look-down image by combining the images of the front camera, the rear camera, and the left and right side cameras, and may generate the bird's-eye image by combining the image captured by the front camera or the rear camera facing the travel direction and the images captured by the left and right side cameras.

The parking assist system 1 is a system for executing the so-called automatic parking process and the so-called automatic unparking process, in which a vehicle is moved autonomously to a prescribed target position (a target parking position or a target unparking position) selected by the occupant so as to park or unpark the vehicle.

The parking assist system 1 includes the control device 15, the brake pedal 24 as a brake input member, the driving operation sensor 12, and the state detecting sensor 13.

The control device 15 controls the powertrain 4, the brake device 5, and the steering device 6 so as to execute an autonomous parking operation to move the vehicle autonomously to a target parking position and park the vehicle at the target parking position and an autonomous unparking operation to move the vehicle autonomously to a target unparking position and unpark the vehicle at the target unparking position. In order to execute such operations, the control device 15 includes an external environment recognizing unit 41, a vehicle position identifying unit 42, an action plan unit 43, a travel control unit 44, a vehicle abnormality detecting unit 45, and a vehicle state determining unit 46.

The external environment recognizing unit 41 recognizes an obstacle (for example, a parked vehicle or a wall) that is present around the vehicle based on the detection result of the external environment sensor 7, and thereby obtains information about the obstacle. Further, the external environment recognizing unit 41 analyzes the images captured by the external cameras 19 based on a known image analysis method such as pattern matching, and thereby determines whether a wheel stopper or an obstacle is present, and obtains the size of the wheel stopper or the obstacle in a case where the wheel stopper or the obstacle is present. Further, the external environment recognizing unit 41 may compute a distance to the obstacle based on signals from the sonars 18 to obtain the position of the obstacle.

Also, by the analysis of the detection result of the external environment sensor 7 (more specifically, by the analysis of the images captured by the external cameras 19 based on a known image analysis method such as pattern matching), the external environment recognizing unit 41 can acquire, for example, a lane on a road delimited by road signs and a parking space delimited by white lines and the like provided on a surface of a road, a parking lot, and the like.

The vehicle position identifying unit 42 identifies the position of the vehicle (the own vehicle) based on a signal from the GPS receiving unit 20 of the navigation device 10. Further, the vehicle position identifying unit 42 may obtain the vehicle speed and the yaw rate from the vehicle sensor 8, in addition to the signal from the GPS receiving unit 20, and identify the position and posture of the vehicle by the so-called inertial navigation.

The travel control unit 44 controls the powertrain 4, the brake device 5, and the steering device 6 based on a travel control instruction from the action plan unit 43 to make the vehicle travel.

The vehicle abnormality detecting unit 45 detects an abnormality of the vehicle (hereinafter referred to as “vehicle abnormality”) based on signals from various devices and sensors. The vehicle abnormality detected by the vehicle abnormality detecting unit 45 includes failure of various devices necessary for driving the vehicle (for example, the powertrain 4, the brake device 5, and the steering device 6) and failure of various sensors necessary for making the vehicle travel autonomously (for example, the external environment sensor 7, the vehicle sensor 8, and the GPS receiving unit 20). Further, the vehicle abnormality includes failure of the HMI 14.

In the present embodiment, the vehicle abnormality detecting unit 45 can detect an abnormality in the screen display of the touch panel 32 based on at least a signal from the touch panel 32.

The vehicle state determining unit 46 acquires the state of the vehicle based on signals from various sensors provided in the vehicle, and determines whether the vehicle is in a prohibition state in which the autonomous movement (namely, the autonomous parking operation or the autonomous unparking operation) of the vehicle should be prohibited. The vehicle state determining unit 46 determines that the vehicle is in the prohibition state when the occupant performs a driving operation (override operation) of the operation input member 11. The override operation is an operation to override (cancel) the autonomous movement (namely, the autonomous parking operation or the autonomous unparking operation) of the vehicle.

More specifically, the vehicle state determining unit 46 may determine the initiation of the override operation when the pressing amount of the brake pedal 24 acquired (detected) by the brake sensor 27 has reached or exceeded a prescribed threshold (hereinafter referred to as “pressing threshold”). Additionally or alternatively, the vehicle state determining unit 46 may determine the initiation of the override operation when a pressing amount of the accelerator pedal 23 acquired (detected) by the accelerator sensor 28 has reached or exceeded a prescribed threshold. The vehicle state determining unit 46 may also determine the initiation of the override operation when a changing rate of the steering angle obtained (detected) by the steering angle sensor 26 has reached or exceeded a prescribed threshold.

Further, the vehicle state determining unit 46 determines, based on the detection result of the state detecting sensor 13, that the vehicle is in the prohibition state when the vehicle is in a state that reflects the alighting intention (intention to alight from the vehicle) of the occupant. More specifically, when the door open/close sensor 29 detects that the door is opened, the vehicle state determining unit 46 determines that the vehicle is in the prohibition state. Also, when the seat belt sensor 30 detects that the seat belt is released, the vehicle state determining unit 46 determines that the vehicle is in the prohibition state.

Further, the vehicle state determining unit 46 determines that, based on the detection result of the state detecting sensor 13, that the vehicle is in the prohibition state when the vehicle is in a state that reflects the absence of intention of the occupant to check the surroundings of the vehicle. More specifically, the vehicle state determining unit 46 determines that the vehicle is in the prohibition state when the door mirror position sensor 31 detects that the door mirror is retracted.

Also, when it is determined, based on the detection result of the state detecting sensor 13, that the door is opened and the seat belt is released, the vehicle state determining unit 46 determines that the alighting intention of the occupant is certain and that the vehicle is in a cancellation state in which the autonomous movement (namely, the autonomous parking operation or the autonomous unparking operation) of the vehicle should be canceled. In addition, the vehicle state determining unit 46 may determine that the vehicle is in the cancellation state when there is an input to a cancellation button displayed on the touch panel 32 while the vehicle is moving autonomously.

In the present embodiment, each vehicle seat provided in the vehicle cabin is provided with a seating sensor configured to detect seating of the occupant. The vehicle state determining unit 46 determines a seating position of the occupant (namely, the vehicle state determining unit 46 identifies the vehicle seat on which the occupant is seated) based on a signal from the seating sensor, and determines that the vehicle is in the cancellation state when the seat belt at the seating position is released and the door near the seating position is opened.

As described above, the driving operation sensor 12 and the state detecting sensor 13 each correspond to the vehicle state detecting device configured to detect the state of the vehicle (for example, the prohibition state in which the autonomous parking operation or the autonomous unparking operation of the vehicle should be prohibited). The vehicle state determining unit 46 determines the state of the vehicle based on the detection results of the driving operation sensor 12 and the state detecting sensor 13. By using the driving operation sensor 12, it is possible to easily detect the override operation of the occupant. By using the state detecting sensor 13, it is possible to easily detect an alighting operation of the user and a change in the state of the vehicle according to an extending/retracting operation of the door mirror.

The action plan unit 43 executes the automatic parking process (autonomous parking operation) or the automatic unparking process (autonomous unparking operation) when the vehicle is in a prescribed state and the HMI 14 or the parking main switch 34 receives a prescribed input by the user, which corresponds to a request for the automatic parking process or the automatic unparking process. More specifically, the action plan unit 43 executes the automatic parking process in a case where a prescribed input corresponding to the automatic parking process is performed when the vehicle is stopped or the vehicle is traveling at a low speed equal to or less than a prescribed vehicle speed (a vehicle speed at which a parking position candidate can be searched for). The action plan unit 43 executes the automatic unparking process (parallel unparking process) in a case where a prescribed input corresponding to the automatic unparking process is performed when the vehicle is stopped. The selection of the process to be executed (the automatic parking process or the automatic unparking process) may be made by the action plan unit 43 based on the state of the vehicle. Alternatively, the above selection may be made by the occupant via the touch panel 32 or the selection input member 35. When executing the automatic parking process, the action plan unit 43 first makes the touch panel 32 display a parking search screen for setting the target parking position. After the target parking position is set, the action plan unit 43 makes the touch panel 32 display a parking screen. When executing the automatic unparking process, the action plan unit 43 first makes the touch panel 32 display an unparking search screen for setting the target unparking position. After the target unparking position is set, the action plan unit 43 makes the touch panel 32 display an unparking screen.

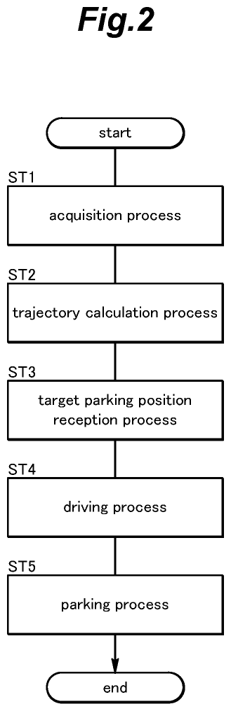

In the following, the automatic parking process will be described with reference to FIG. 2. The action plan unit 43 first executes an acquisition process (step ST1) to acquire one or more parking spaces, if any. More specifically, in a case where the vehicle is stopped, the action plan unit 43 first makes the touch panel 32 of the HMI 14 display a notification that instructs the occupant to move the vehicle straight. While the occupant sitting in the driver's seat (hereinafter referred to as “driver”) is moving the vehicle straight, the external environment recognizing unit 41 acquires, based on a signal from the external environment sensor 7, a position and size of each detected obstacle and positions of the white lines provided on the road surface. The external environment recognizing unit 41 extracts, based on the acquired position and size of the obstacle and the acquired positions of the white lines, one or more undelimited parking spaces and one or more delimited parking spaces, if any (hereinafter, the undelimited parking spaces and the delimited parking spaces will be collectively referred to as “parking spaces”). Each undelimited parking space is a space that is not delimited by the white lines or the like, has a size sufficient to park the vehicle, and is available (namely, there is no obstacle therein). Each delimited parking space is a space that is delimited by the white lines or the like, has a size sufficient to park the vehicle, and is available (namely, another vehicle (vehicle other than the own vehicle) is not parked).

Next, the action plan unit 43 executes a trajectory calculation process (step ST2) to calculate a trajectory of the vehicle from a current position of the vehicle to each extracted parking space. In a case where the trajectory of the vehicle can be calculated for a certain parking space, the action plan unit 43 sets the parking space as a parking position candidate where the vehicle can be parked, and make the touch panel 32 display the parking position candidate on the screen (the parking search screen). In a case where the trajectory of the vehicle cannot be calculated due to the presence of the obstacle, the action plan unit 43 does not set the parking space as a parking position candidate and does not make the touch panel 32 display the parking space on the screen. When the action plan unit 43 sets multiple parking position candidates (namely, multiple parking places for which the trajectory of the vehicle can be calculated), the action plan unit 43 makes the touch panel 32 display these parking position candidates.

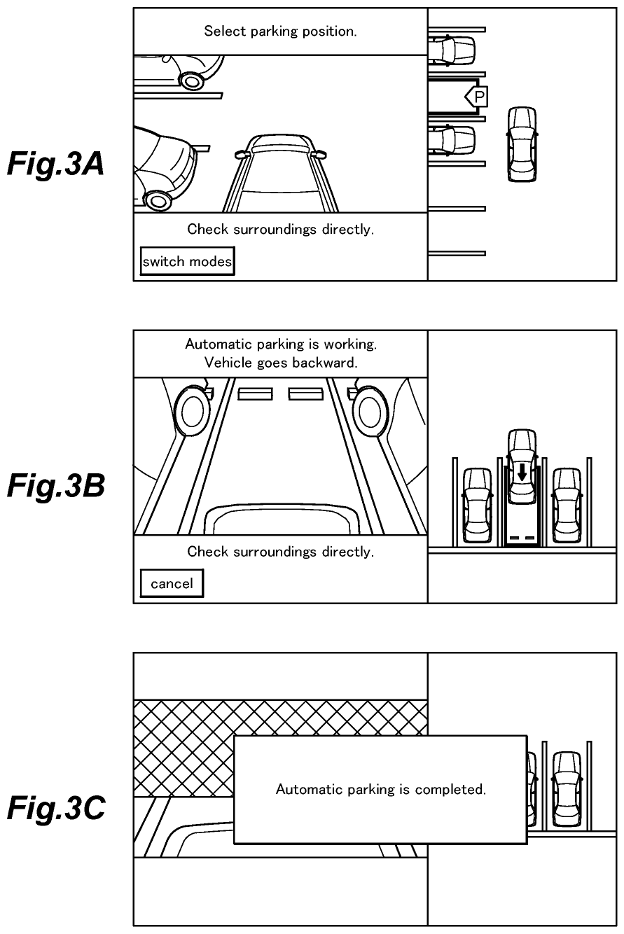

Next, the action plan unit 43 executes a target parking position reception process (step ST3) to receive a selection operation performed by the occupant to select the target parking position, which is a parking position where the occupant wants to park the vehicle, and is selected from the one or more parking position candidates displayed on the touch panel 32. More specifically, the action plan unit 43 makes the touch panel 32 display the look-down image and the bird's-eye image in the travel direction on the parking search screen shown in FIG. 3A. When the action plan unit 43 acquires at least one parking position candidate, the action plan unit 43 makes the touch panel 32 display a frame that indicates the parking position candidate and an icon that corresponds to the frame in at least one of the look-down image and the bird's-eye image (in the look-down image in FIG. 3A) in an overlapping manner. The icon consists of a symbol indicating the parking position candidate (see “P” in FIG. 3A). Also, the action plan unit 43 makes the touch panel 32 display the parking search screen including a notification that instructs the driver to stop the vehicle and select the target parking position, so that the touch panel 32 receives the selection operation of the target parking position. The selection operation of the target parking position may be performed via the touch panel 32, or may be performed via the selection input member 35.

After the vehicle is stopped and the target parking position is selected by the driver, the action plan unit 43 makes the touch panel 32 switch the screen from the parking search screen to the parking screen. As shown in FIG. 3B, the parking screen is a screen in which an image in the travel direction of the vehicle (hereinafter referred to as “travel direction image”) is displayed on the left half of the touch panel 32 and the look-down image including the vehicle and its surrounding area is displayed on the right half thereof. At this time, the action plan unit 43 may make the touch panel 32 display a thick frame that indicates the target parking position selected from the parking position candidates and an icon that corresponds to the thick frame such that the thick frame and the icon overlap with the look-down image. This icon consists of a symbol indicating the target parking position, and is shown in a color different from the symbol indicating the parking position candidate.

After the target parking position is selected and the screen of the touch panel 32 is switched to the parking screen, the action plan unit 43 executes a driving process (step ST4) to make the vehicle travel along the calculated trajectory. At this time, the action plan unit 43 controls the vehicle based on the position of the vehicle acquired by the GPS receiving unit 20 and the signals from the external cameras 19, the vehicle sensor 8, and the like so that the vehicle travels along the calculated trajectory. At this time, the action plan unit 43 controls the powertrain 4, the brake device 5, and the steering device 6 so as to execute a switching operation for switching the travel direction of the vehicle (a reversing operation for reversing the travel direction of the vehicle). The switching operation may be executed repeatedly, or may be executed only once.

During the driving process, the action plan unit 43 may acquire the travel direction image from the external cameras 19 and make the touch panel 32 display the acquired travel direction image on the left half thereof. For example, as shown in FIG. 3B, when the vehicle is moving backward, the action plan unit 43 may make the touch panel 32 display an image to the rear of the vehicle captured by the external cameras 19 on the left half thereof. While the action plan unit 43 is executing the driving process, the surrounding image of the vehicle (the own vehicle) in the look-down image displayed on the right half of the touch panel 32 changes along with the movement of the vehicle. When the vehicle reaches the target parking position, the action plan unit 43 stops the vehicle and ends the driving process.

When the driving process ends, the action plan unit 43 executes a parking process (step ST5). In the parking process, the action plan unit 43 first drives the shift actuator 17 to set the shift position (shift range) to a parking position (parking range). Thereafter, the action plan unit 43 drives the parking brake device 53, and makes the touch panel 32 display a pop-up window (see FIG. 3C) indicating that the automatic parking of the vehicle has been completed. The pop-up window may be displayed on the screen of the touch panel 32 for a prescribed period. Thereafter, the action plan unit 43 may make the touch panel 32 switch the screen to an operation screen of the navigation device 10 or a map screen.

In the parking process, there may be a case where the shift position cannot be changed to the parking position because of an abnormality of the shift actuator 17 or a case where the parking brake device 53 cannot be driven because of an abnormality of the parking brake device 53. In these cases, the action plan unit 43 may make the touch panel 32 display the cause of the abnormality on the screen thereof.

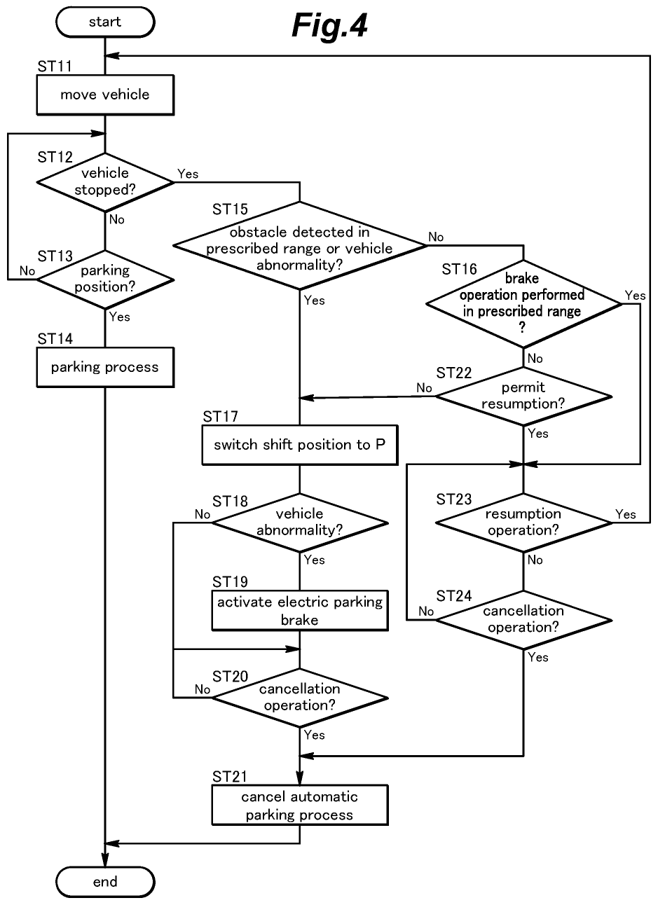

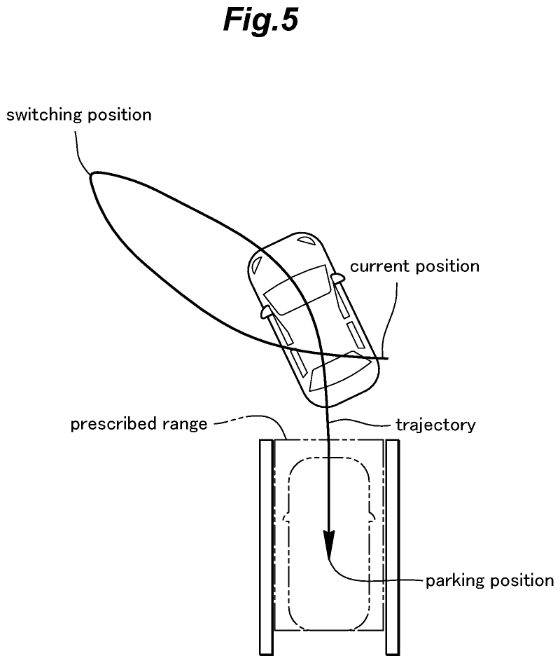

Next, with reference to FIGS. 1 and 4 to 6, the details of the automatic parking process will be described with regard to a case where the vehicle is stopped during the automatic parking process before the vehicle reaches the parking position. Incidentally, the brake device 5 includes a main brake device 51 (regularly used brake device) and the above electric parking brake device 53. The main brake device 51 is configured to be driven according to pressing of the brake pedal 24 by the driver so as to apply the brake force to the vehicle. The parking brake device 53 is configured to be driven according to a pull of a parking brake lever 52 (an example of the operation input member 11) by the driver so as to apply the brake force to the vehicle. That is, the brake device 5 (the main brake device 51 and/or the parking brake device 53) is driven so as to apply the brake force to the vehicle, which will be simply referred to as “the brake device 5 is driven”. The control device 15 can drive the main brake device 51 and the parking brake device 53. In the following, the brake pedal 24 and the parking brake lever 52 may be collectively referred to as brake operation members 24, 52.

The trajectory (travel route), along which the vehicle should move forward from the current position, stop at the switch position, and move backward to stop in the parking position, has been calculated by the action plan unit 43 (see ST2 in FIG. 2). The travel control unit 44 causes the vehicle to move along the trajectory (ST11). During the movement of the vehicle, the control device 15 monitors whether the vehicle is stopped (ST12). When the vehicle reaches the parking position (Yes in ST13), the control device 15 performs a parking process (ST14, which corresponds to ST5 in FIG. 2), which includes stopping the vehicle, etc., and ends the automatic parking process.

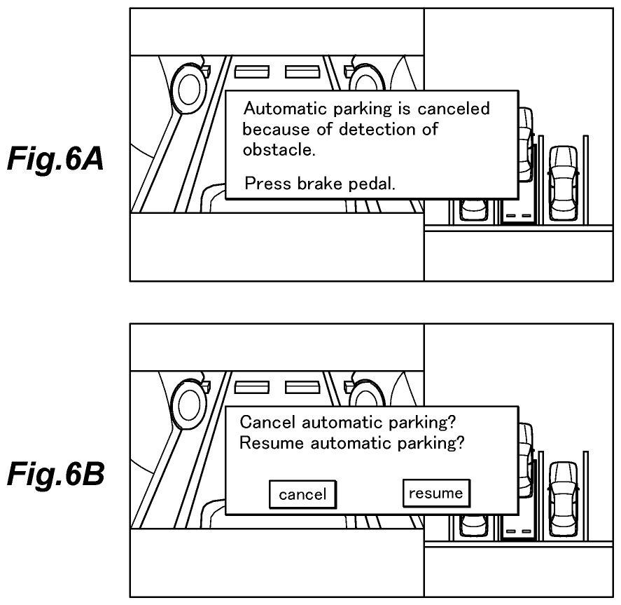

When the vehicle is stopped (Yes in ST12) before reaching the parking position (No in ST13), the control device 15 performs a process in accordance with the position where the vehicle is stopped and the cause for the stop. In a case where the vehicle is stopped according to detection of an obstacle in a prescribed range from the parking position by the external environment sensor 7 or detection of an abnormality of the vehicle by the vehicle abnormality detecting unit 45 (Yes in ST15), the action plan unit 43 switches the shift position of the shift lever 25 to P (parking) (ST17). Further, in the case where the vehicle is stopped according to detection of an abnormality of the vehicle by the vehicle abnormality detecting unit 45 (Yes in ST18), the action plan unit 43 activates the electric parking brake device 53 (ST19). The action plan unit 43 causes the touch panel 32 to pop-up display a message indicating that the automatic parking process will be canceled and a message prompting the driver to press the brake pedal 24 (see FIG. 6A). If the driver performs a cancellation operation, such as pressing of the brake pedal 24, for canceling the automatic parking process (Yes in ST20), the control device 15 cancels the automatic parking process (ST21).

The “prescribed range” is a range in the vicinity of the parking position. For example, in a case where the parking position is set as a parking place delimited by white lines, the prescribed range may be a range defined between two white lines on lateral sides of the parking position and between the front end of the two white lines and the rear end of the vehicle in the parking position. Alternatively, the “prescribed range” may be a range defined between the positions respectively apart from the left and right ends of the parking position by a prescribed distance (for example, 0.3 m to 1 m) and between the position apart from the front end of the parking position by a prescribed distance (for example, 0.5 m to 2 m) and the rear end of the parking position. Also, in a case where the parking position is set for perpendicular parking, the fore and aft dimension of the “prescribed range” may be defined as a dimension between a line connecting the front ends of two vehicles that, of the other vehicles that are parked in a perpendicular manner, protrude the most into the road and the rear end of the instant vehicle in the parking position. Note that here, the terms “the front end” and “the rear end” are used with an assumption that the vehicle is parked with the front part thereof facing the road, and in a case where the vehicle is parked in the opposite direction, the front and rear are switched.

In a case where the vehicle is stopped according to an operation of the brake operation member 24, 52 by the driver in the prescribed range (Yes in ST16), the control device 15 permits resumption of movement of the vehicle in the automatic parking process. The action plan unit 43 causes the touch panel 32 to pop-up display a cancellation button for canceling the automatic parking process and a resumption button for resuming the movement of the vehicle in the automatic parking process (FIG. 6B). If the driver performs a resumption operation such as pressing of the resumption button (Yes in ST23), the travel control unit 44 resumes the movement of the vehicle along the travel route (ST11). If the driver performs a cancellation operation such as pressing of the cancellation button (Yes in ST24), the control device 15 cancels the automatic parking process (ST21). The cancellation operation includes pressing of the brake pedal 24 by the driver and/or pulling of the parking brake lever 52 by the driver, and the action plan unit 43 continues to perform the control, such as maintaining activation of the main brake device 51, until the brake sensor 27 detects these operations.

Setting is made in the control device 15 to determine whether to permit the resumption of the automatic parking process based on various factors (such as the cause of the stop of the vehicle and the position of the vehicle when the vehicle is stopped) in the case where the vehicle is stopped but the conditions defined in ST15 and ST16 are not satisfied (No in both ST15 and ST16). When the resumption is permitted (Yes in ST22), the control device 15 executes the control same as that executed when the vehicle is stopped due to the brake operation in the prescribed range (Yes in ST16), and when the resumption is not permitted (No in ST22), the control device 15 executes the control same as that executed when the obstacle is detected in the prescribed range or when failure of the vehicle is detected (Yes in ST15).

In a case where the vehicle is stopped according to failure of the parking assist system 1 or detection of an obstacle in the prescribed range by the external environment sensor 7, the control device 15 cannot continue the automatic parking process, and therefore, the control device 15 cancels the automatic parking process. On the other hand, in the case where the vehicle is stopped according to the brake operation of the driver, it may be considered, for example, that the driver felt a risk that the vehicle may collide with an obstacle though, objectively, there is no risk that the vehicle may collide with the obstacle or the driver is waiting for a pedestrian to pass, and thus, it is probable that there is no need to cancel the automatic parking process. Therefore, in such cases, the parking assist system 1 permits the resumption of the automatic parking process, thereby to improve the driver's convenience.

When canceling the automatic parking process, the parking assist system 1 switches the shift position of the shift lever 25 to “P” to fix the vehicle in place and improve the safety. Further, when canceling the automatic parking process according to detection of failure in the vehicle, the parking assist system 1 activates the electric parking brake device 53 to fix the vehicle in place more reliably and improve the safety.

Since the parking assist system 1 requests the driver to perform a brake operation before canceling the automatic parking process, the driver can easily recognize that vehicle control will be transferred to the driver.

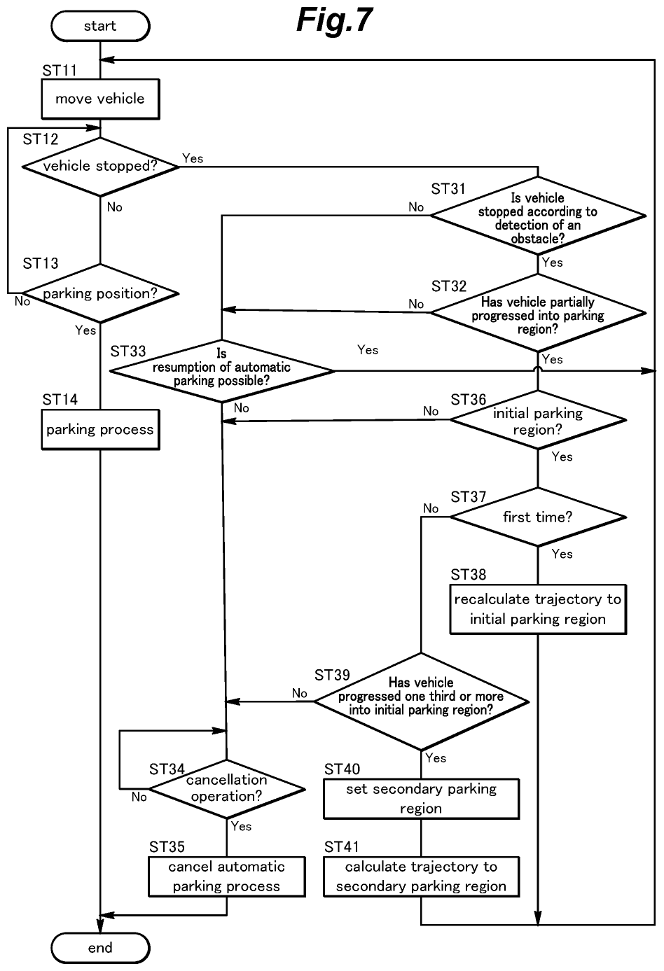

Another embodiment will be described below with reference to FIGS. 1, 7, and 8. The functional configuration diagram of the vehicle according to this embodiment is the same as the functional configuration diagram of the vehicle according to the foregoing embodiment shown in FIG. 1. The present embodiment differs from the foregoing embodiment with respect to the control performed when an obstacle is detected near the parking position.

Near the parking position, there may be a case where another vehicle that has already parked becomes an obstacle. In such a case, requesting the driver to perform the cancellation operation to cancel the automatic parking process that is being executed and to perform the start operation of a new automatic parking process so that a new trajectory is calculated would cause inconvenience to the driver and would take a longer time to complete the parking.

In view of such a problem, an object of the present embodiment is to provide a parking assist system 1 that can improve the driver's convenience and reduce the time until the completion of parking. The present embodiment is suitable for perpendicular parking or angle parking.

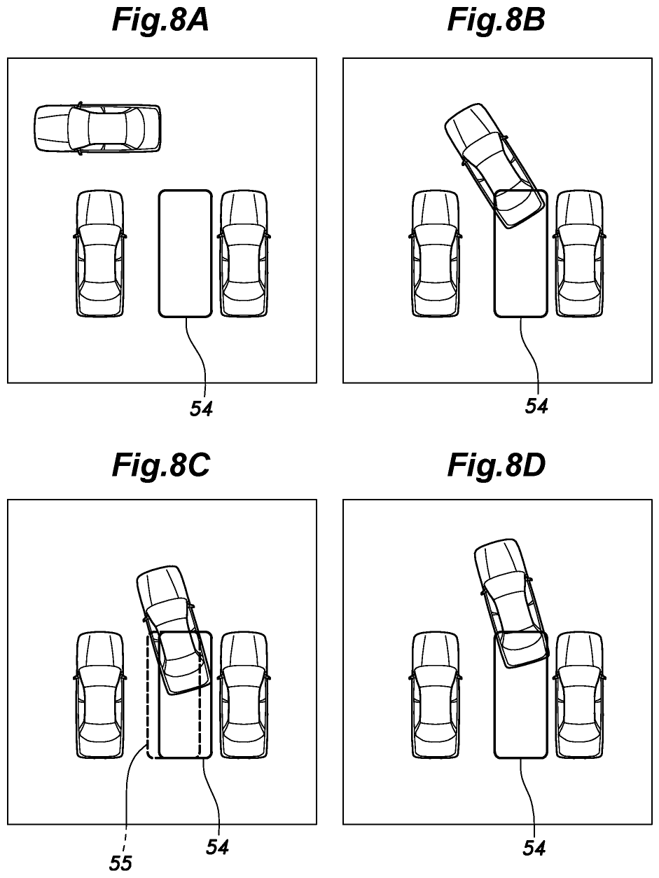

The action plan unit 43 sets an initial parking region 54 having a substantially rectangular shape and inscribed in an outline of the vehicle parked in the parking position as viewed in plan view (FIG. 8A), and when a condition that is described later is satisfied, sets a secondary parking region 55 having a substantially rectangular shape and inscribed in the outline of the vehicle parked in a newly set parking position (FIG. 8C). The initial parking region 54 and the secondary parking region 55 each have parallel sides in the fore and aft direction and the lateral direction of the vehicle parked in the corresponding parking position. The initial parking region 54 and the secondary parking region 55 may be collectively referred to as a “parking region.”

The moving of the vehicle (ST11), monitoring of vehicle stop (ST12), confirmation of reaching the parking position (ST13), and parking process (ST14), which are performed after the start of the automatic parking process, are the same as in the foregoing embodiment.

In a case where the vehicle is stopped at a position other than the parking position and the switch position (Yes in ST12), if the vehicle is not stopped according to detection of an obstacle by the external environment sensor 7 (No in ST31) or the vehicle has not progressed into the parking region even partially (No in ST32), the control device 15 determines whether the resumption of the automatic parking process is possible, and if possible (Yes in ST33), the control device 15 resumes the movement of the vehicle (ST11), and if the resumption of the automatic parking process is not possible (No in ST33), the control device 15 causes the touch panel 32 or the like to display a message prompting pressing of the brake pedal 24, and when a cancellation operation such as pressing of the brake pedal 24 by the driver is performed (Yes in ST34), the control device 15 cancels the automatic parking process (ST35).

In a case where the vehicle is stopped according to the detection of an obstacle by the external environment sensor 7 (Yes in ST31) and the vehicle has partially progressed into the parking region (Yes in ST32, FIG. 8B), if the parking region is the initial parking region 54 (Yes in ST36) and the vehicle has progressed into the initial parking region 54 for the first time (Yes in ST37), the action plan unit 43 recalculates the trajectory reaching the initial parking region 54 and avoiding the detected obstacle (ST38) and the travel control unit 44 causes the vehicle to move along the recalculated trajectory (ST11). If the parking region is not the initial parking region 54 (No in ST36), namely, if the parking region is the secondary parking region 55, the control device 15 causes the touch panel 32 or the like to display a message prompting pressing of the brake pedal 24, and when a cancellation operation such as pressing of the brake pedal 24 by the driver is performed (Yes in ST34), the control device 15 cancels the automatic parking process (ST35).

In a case where the vehicle has progressed into the initial parking region 54 for the second time (No in ST37), if the vehicle has progressed one third or more of the fore and aft length of the initial parking region 54 into the initial parking region 54 (Yes in ST39, FIG. 8C), the action plan unit 43 sets the secondary parking region 55 (ST40) and calculates the trajectory reaching the secondary parking region 55 and avoiding the obstacle (ST41), and the travel control unit 44 causes the vehicle to move along the trajectory (ST11). The secondary parking region 55 is set at a position more remote from the detected obstacle in the lateral direction than the initial parking region 54 is.

If the vehicle has not progressed one third or more of the fore and aft length of the initial parking region 54 into the initial parking region 54 (No in ST39, FIG. 8 D), the control device 15 causes the touch panel 32 or the like to display a message prompting pressing of the brake pedal 24, and when a cancellation operation such as pressing of the brake pedal 24 by the driver is performed (Yes in ST34), the control device 15 cancels the automatic parking process (ST35).

FIGS. 8A to 8D show an example in which the obstacle is another vehicle parked near the initial parking region 54 and on the side of the outer wheels of the vehicle on which the automatic parking process is performed, but the obstacle may be an object other than another vehicle.

In the flow of a single automatic parking process, the trajectory to the initial parking region 54 may be recalculated and/or the secondary parking region 55 may be set as necessary, and therefore, the driver is not required to perform an operation for canceling the automatic parking process and an operation for starting a new automatic parking process each time an obstacle is detected, whereby the driver's convenience is improved and the time until the completion of parking can be reduced.

Since the secondary parking region 55 is set when the vehicle has progressed one third or more of the fore and aft length of the initial parking region 54 into the initial parking region 54, the possibility that the external environment sensor 7 may detect an obstacle having a risk of collision during the movement of the vehicle along the trajectory to the secondary parking region 55 is low.

Since the recalculation of the trajectory to the initial parking region 54 is allowed to be performed only once and the trajectory to the secondary parking region 55 is not recalculated, recalculation of the trajectory to a position where parking is difficult is prevented from being performed many times, and an increase in time until the completion of parking can be suppressed.

The initial parking region 54 and the secondary parking region 55 each has a simple, substantially rectangular shape adapted to be inscribed in the image of the vehicle, and thus can be easily set in mutually offset positions in a prescribed parking area.

Concrete embodiments of the present invention have been described in the foregoing, but the present invention should not be limited by the foregoing embodiments and various modifications and alterations are possible within the scope of the present invention. For example, the shift lever 25 may be replaced with a device other than a lever. In the embodiment in which the initial parking region 54 and the secondary parking region 55 are set, the trajectory to the initial parking region 54 may be recalculated a prescribed number of times that is equal to two or more.

1. A parking assist system for a vehicle including a powertrain, a brake device, and a steering device, the parking assist system comprising:
a control device configured to execute an automatic parking process for autonomously moving the vehicle from a current position to a parking position; and
a vehicle position detection device including an external environment sensor configured to detect an obstacle, the vehicle position detection device being configured to detect a position of the vehicle relative to a travel route for the automatic parking process,
wherein the vehicle includes a brake operation member that can be operated by a driver to operate the brake device, and
the control device is configured such that in a case where the control device has stopped the vehicle according to detection of the obstacle by the external environment sensor in a prescribed range from the parking position during execution of the automatic parking process, the control device does not permit resumption of movement of the vehicle in the automatic parking process, and in a case where the control device has stopped the vehicle according to an operation of the brake operation member by the driver in the prescribed range from the parking position during the execution of the automatic parking process, the control device permits the resumption of movement of the vehicle in the automatic parking process.

2. The parking assist system according to claim 1, wherein
the powertrain includes a transmission,
the vehicle further includes a shift device that can be operated by the driver to operate the transmission, and
the control device is configured to switch a shift range of the shift device to a parking range in a case where the control device does not permit the resumption of movement of the vehicle in the automatic parking process.

3. The parking assist system according to claim 2, further comprising a brake sensor configured to detect an operation of the brake operation member by the driver for activating the brake device,
wherein when the brake sensor detects the operation of the brake operation member by the driver after the control device has stopped the vehicle and switched the shift range of the shift device to the parking range, the control device ends the automatic parking process.

4. The parking assist system according to claim 2, wherein
the brake device includes a parking brake device, and
the control device is configured such that in a case where the control device has stopped the vehicle according to detection of an abnormality in the vehicle during the automatic parking process, the control device does not permit the resumption of movement of the vehicle in the automatic parking process, switches the shift range of the shift device to the parking range, and activates the parking brake device.

5. The parking assist system according to claim 3, wherein
the brake device includes a parking brake device, and
the control device is configured such that in a case where the control device has stopped the vehicle according to detection of an abnormality in the vehicle during the automatic parking process, the control device does not permit the resumption of movement of the vehicle in the automatic parking process, switches the shift range of the shift device to the parking range, and activates the parking brake device.
